(19) United States
(12) Patent Application Publication
(10) Pub. No.: US 2026/0337403 A1
(43) Pub. Date: Oct. 29, 2026

(54) TEMPERATURE-SENSITIVE SILICONE-RUBBER-BASED COMPOSITE AND METHODS FOR FABRICATING THE SAME

(71) Applicant: Nano and Advanced Materials Institute Limited, Hong Kong (HK)

(72) Inventors: Yingshun LI, Hong Kong (HK); Pao Chieh WANG, Hong Kong (HK); Yangfan ZHOU, Hong Kong (HK); Jianping HAN, Hong Kong (HK); Yong ZHU, Hong Kong (HK); Li FU, Hong Kong (HK); Chenmin LIU, Hong Kong (HK)

(21) Appl. No.: 19/562,857

(22) Filed: Mar. 11, 2026

Related U.S. Application Data
(60) Provisional application No. 63/790,762, filed on Apr. 18, 2025.

(51) Int. Cl. C08L 67/06; B29C 45/00; B29K 83/00; B29K 105/24; C08L 83/04

(52) U.S. Cl. CPC C08L 67/06; C08L 83/04; B29C 45/0001; B29K 2083/005; B29K 2105/24; C08L 2203/30; C08L 2312/00

(57) ABSTRACT

The present invention relates to a temperature-sensitive composite comprising a silicone rubber matrix and a bio-based aliphatic unsaturated polyester phase, engineered to resolve the technical conflict between anatomical adaptability and structural stability in wearables. The invention achieves a sharp mechanical transition triggered by human body heat by precisely tailoring the molecular architecture, specifically through the regulation of odd-even carbon ratios in the alkyl chains to disrupt crystalline packing. This molecular engineering ensures a decisive reduction in hardness within the physiological temperature window, allowing the material to conform to unique anatomical contours upon skin contact. Furthermore, the incorporation of unsaturated units facilitates a post-crosslinked network that forms a dual-phase synergistic structure, enabling the material to maintain essential structural integrity and tactile texture even in a softened state. This system offers a sustainable solution for injection-molded wearables, ensuring consistent conformability and mechanical durability under cyclic temperature variations.

### CROSS-REFENCE TO RELATED APPLICATIONS

The present application claims priority from U.S. Provisional Patent Application No. 63/790,762 filed Apr. 18, 2025, and the disclosure of which is incorporated herein by reference in its entirety.

### FIELD OF THE INVENTION

The present invention generally relates to the field of silicone-rubber-based composite materials.

### BACKGROUND OF THE INVENTION

Wearable devices, such as earbuds, smartwatch bands, and medical wearables, increasingly rely on silicone-based materials due to their durability, non-allergenic properties, and flexibility. Silicone elastomers dominate the market for wearable and skin-contact device manufacturing, particularly for injection-molded components, as they balance softness with structural integrity. However, conventional silicone technologies face a critical challenge in achieving optimal comfort while maintaining a secure fit. Traditional silicone materials often fail to adapt to the unique contours of the user's body, which may lead to contact pressure, poor fit, and reduced device performance. For example, in earbud applications, the ear canal's unique shape requires a material that can conform precisely to individual contours without causing discomfort during prolonged use. Conventional silicone ear tips, while generally biocompatible, typically exhibit static stiffness and do not adapt to body temperature or pressure variations. This rigidity may result in user fatigue, improper fitting, or slippage, thereby compromising both comfort and audio performance. Similarly, watchbands made from standard silicone rubbers may generate localized pressure points or fail to retain their shape over time, thereby reducing wearability and overall user comfort.

Current solutions to the problem include the use of thermoplastic elastomers (TPEs) or hybrid silicone blends engineered for enhanced softness of a silicone rubber (e.g., Chinese Patent Application Publication no. CN107018664A). However, softer materials often sacrifice mechanical stability, leading to reduced product lifespan or unsteady fitting. Moreover, these kinds of materials do not exhibit temperature adaptable properties, limiting the biocompatibility at body temperature. Multi-material designs, such as layered structures combining rigid and soft zones, have also been explored. Yet these approaches complicate manufacturing processes, increase costs, and often lack precision.

Additionally, many conventional polymers rely on non-sustainable resources, conflicting with growing demand for sustainable manufacturing practices. For example, PCT International Patent Application Publication no. WO2024147395A1 and WO2023068853A1 incorporate temperature-sensitive shape memory functions into silicone rubber using materials like caprolactone and glycidyl methacrylate, both of which are typically derived from petrochemical sources. While these approaches enable silicone to adapt to temperature changes, they are limited by the inherent properties of the materials used. Specifically, polycaprolactone has an equilibrium melting point of 55 °C₁₋₁₅, which restricts the ability to fine-tune the melting and transition temperatures within the desired range of 20 °C to 40 °C, crucial for wearable products that need to respond effectively to body temperature, usually between 28 °C and 38 °C.

Thus, there is a need for a silicone-based material with improved temperature adaptability and mechanical stability, addressing the limitations of traditional silicone technologies. This material should provide comfort, secure fit, and durability in wearable devices, while remaining soft, flexible, and sustainably sourced.

### SUMMARY OF THE INVENTION

The present invention provides a novel silicone rubber and bio-based aliphatic unsaturated polyester composite material, engineered to address the critical challenge of balancing dynamic comfort and structural firmness in wearable devices. Specifically, the primary object of the present invention is to overcome the long-standing technical conflict between anatomical adaptability and structural stability.

In a first aspect, the present invention provides a temperature-sensitive silicone-rubber-based composite. The composite includes 20 to 90 parts by weight of a silicone rubber matrix, 10 to 80 parts by weight of a temperature-sensitive elastic polymer dispersed within the silicone rubber matrix, and 0.1 to 30 parts by weight of additives including a crosslinking initiator. The temperature-sensitive elastic polymer incudes an aliphatic unsaturated polyester having a back-bone structured to undergo a crystalline-to-amorphous phase transition within a physiological temperature window of 20 °C to 40 °C. The silicone rubber matrix and a post-crosslinked network of the aliphatic unsaturated polyester form a dual-phase synergistic structure, such that the temperature-sensitive silicone-rubber-based composite exhibits a reduction in Shore A hardness of at least 20 units upon reaching the phase transition while maintaining structural elasticity.

In one embodiment, the aliphatic unsaturated polyester comprises a polyester structure represented by Formula (I):

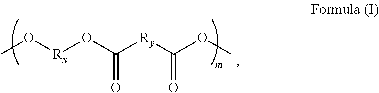

where Rₓ and R_{y} are independently selected from the group consisting of C₁₋₁₅ straight-chain alkyl groups, C₁₋₁₅ branched alkyl groups, and C₂₋₁₅ alkenyl groups containing at least one carbon-carbon double bond, and m is an integer greater than or equal to 1.

In one embodiment, Rₓ contains at least two alkyl components, one having an odd carbon number and the other having an even carbon number, configured to regulate the crystalline packing of the polyester. R_{y} contains an unsaturated aliphatic group configured to form the post-crosslinked network with the silicone rubber matrix.

In one embodiment, the temperature-sensitive elastic polymer exhibits a melting enthalpy of at least 50 J/g as measured by Differential Scanning calorimetry (DSC), to ensure a non-linear mechanical transition within the physiological temperature window.

In one embodiment, the temperature-sensitive elastic polymer has a melting temperature between 30 °C and 40 °C The temperature-sensitive elastic polymer has a crystallization temperature between 10 °C and 21 °C.

In one embodiment, the ratio of an elastic modulus at 10 °C to an elastic modulus at 40 °C of the temperature-sensitive silicone-rubber-based composite is at least 5.8.

In one embodiment, the temperature-sensitive silicone-rubber-based composite exhibits a Shore A hardness variation of 0.1 to 70 units within a temperature range from 10 °C to 45 °C.

In one embodiment, the temperature-sensitive elastic polymer has a weight average molecular weight in the range of 10 kDa to 100 kDa.

In one embodiment, the silicone rubber matrix includes a thermosetting silicone selected from the group consisting of polydimethylsiloxane (PDMS) and vinyl-functionalized silicone elastomers.

In one embodiment, the additives include peroxides, platinum-based catalysts, azo compounds, photo initiators or thermal initiators, reinforcing fillers, or other silicone additives.

In one embodiment, the post-crosslinked network is formed by radical polymerization of unsaturated units within the polyester triggered by the crosslinking initiator during a molding process.

In one embodiment, the temperature-sensitive silicone-rubber-based composite maintains a Shore A hardness at 45 °C after at least 30 repeat heating-cooling cycles between 10 °C and 70 °C.

In one embodiment, the temperature-sensitive silicone-rubber-based composite maintains an elastic modulus of no less than 2.7 MPa at 40 °C to prevent structural collapse in a softened state.

In one embodiment, the temperature-sensitive silicone-rubber-based composite is an injection-molded component for a wearable device, configured to anatomically conform to a user's skin surface upon contact.

In another aspect, the present invention provides a method for fabricating a temperature-sensitive silicone-rubber-based composite, including (a) mixing a silicone rubber with additives to form a base mixture; (b) incorporating a temperature-sensitive elastic polymer into the base mixture; (c) homogenizing the mixture via a kneading process conducted under an inert gas atmosphere; and (d) molding the homogenized mixture into a predetermined shape at a temperature between 100 °C and 190 °C to simultaneously trigger shaping and crosslinking of the temperature-sensitive elastic polymer.

In another embodiment, the method further includes a post-curing step at a temperature between 100 °C and 150 °C for a duration of 4 to 20 hours.

In one embodiment, the molding process is performed under vacuum conditions to minimize air entrapment and defects within the dual-phase synergistic structure.

In one embodiment, the temperature-sensitive elastic polymer is pre-synthesized from bio-based diols and dicarboxylic acids to have a melting temperature tailored to 20 °C to 40 °C via regulation of odd-even carbon ratios in its molecular backbone.

A critical technical breakthrough of the present invention lies in the precisely tailored molecular architecture of the thermo-responsive polymer phase, which is engineered to achieve a sharp, controllable mechanical transition within a critical physiological window of 20 °C-40 °C Unlike prior art materials (e.g., polycaprolactone) that exhibit melting points far exceeding skin tolerance (typically above 55 °C), the present invention utilizes a strategic regulation of alkyl chain lengths and odd-even carbon number ratios within the polymer backbone (Rₓ and Ry) to disrupt crystalline packing with high precision. This molecular engineering enables the composite to exhibit a non-linear, dramatic reduction in Shore A hardness—with a variation of up to 70 units- and an elastic modulus ratio (E′10 °C/E′40 °C) of at least 5, allowing the material to conform precisely to unique anatomical contours upon contact with body heat.

Furthermore, the present invention resolves a significant technical bias in material science: the inherent loss of mechanical integrity in polymers during thermal softening. By incorporating unsaturated aliphatic units capable of post-crosslinking, the invention creates a dual-phase synergistic structure. While the dispersed polymer phase undergoes phase transition to provide adaptive softness, the silicone rubber matrix and the crosslinked network maintain essential structural elasticity and durability, preventing the device from losing its functional shape or tactile texture. This “soft-yet-firm” synergistic mechanism provides a level of dynamic comfort and structural retention that cannot be achieved by mere physical blending of generic elastomers.

The present invention further distinguishes itself by prioritizing environmental sustainability without compromising technical performance. By utilizing bio-based monomers derived from naturally sourced diols and dicarboxylic acids, the formulation maintains a controlled degree of crystallinity that enhances temperature responsiveness. This dual focus on high-performance mechanical adaptability and eco-friendly material design represents a significant advancement over existing petroleum-based technologies, making it an ideal solution for advanced consumer electronics and medical wearable applications.

### BRIEF DESCRIPTION OF THE DRAWINGS

Embodiments of the invention are described in more details hereinafter with reference to the drawings, in which:

FIG. 1 illustrates the transition temperature identification from differential scanning calorimetry (DSC) test result (demonstrated by the polyester UAP01 from Example 2);

FIG. 2 depicts the results of the DMA testing;

FIG. 3 presents the Shore A hardness test results;

FIG. 4 depicts a graph illustrating the cyclic heating and cooling temperature profile applied to the temperature-sensitive silicone composite (UAP03) during the durability testing sequence; and

FIG. 5 depicts a graph showing the dynamic mechanical analysis (DMA) results of the comparative silicone composite (SC09) prepared in Comparative Example 2.

### DETAILED DESCRIPTION

### DEFINITIONS

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

As used herein, the term “temperature-sensitive elastic polymer” refers to a polymeric material that exhibits a reversible change in at least one mechanical property in response to a change in temperature within a predetermined temperature range.

As used herein, the term “transition temperature” refers to a temperature at which a thermal or mechanical phase transition of a polymer is detectable by differential scanning calorimetry, dynamic mechanical analysis, or hardness measurement.

As used herein, the term “physiological temperature range” refers to a temperature range corresponding to temperatures encountered during contact with a human body.

As used herein, the term “elastic modulus ratio” refers to a ratio of storage modulus values measured at two different temperatures under identical dynamic mechanical analysis conditions.

As used herein, the term “odd-even carbon number regulation” refers to the selection and incorporation of polymer building units having alkyl chains with odd-numbered and even-numbered carbon atoms in a controlled manner within a polymer structure.

As used herein, the term “post-crosslinking” refers to a crosslinking reaction that occurs after formation of a polymer backbone through activation of reactive groups within the polymer.

As used herein, the term “dual-phase synergistic structure” refers to a composite structure comprising a silicone rubber phase and a temperature-sensitive elastic polymer phase coexisting within the material.

As used herein, the term “temperature-sensitive silicone-rubber-based composite” refers to a composite material comprising a silicone rubber matrix and a temperature-sensitive elastic polymer dispersed therein.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

In the following description, temperature sensitive silicone rubber polyester composites, methods of fabrication the same and application thereof are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

While conventional silicone elastomers offer durability, they possess a static stiffness that fails to accommodate the unique and complex contours of individual human anatomy-such as the ear canal or wrist-leading to localized pressure, discomfort, and compromised device performance. By precisely engineering the molecular architecture of the bio-based unsaturated polymer phase, the present invention provides a material system capable of a sharp, predictable mechanical response triggered by human body heat. This allows the composite to soften and conform precisely to the user's skin within a critical physiological window while maintaining essential structural integrity, elasticity, and tactile texture through its resilient silicone matrix.

In particular, the present invention provides a temperature-sensitive silicone-rubber-based composite material, method of its fabrication and application thereof. This temperature-sensitive composite is specifically designed for use in injection moldable wearable applications, such as earbud tips, smartwatch bands, and medical wearables, where precise fit, comfort, and durability are essential.

The temperature-sensitive silicone-rubber-based composite material includes the following components: 20 to 90 parts by weight of a silicone rubber, 10 to 80 parts by weight of a temperature-sensitive elastic polymer, and 0.1 to 30 parts by weight of additives.

Silicone rubber, which serves as the base material, is selected from either A/B two-component or one-component silicone rubber formulations. It provides essential skin-friendly properties, including softness, biocompatibility, and flexibility. The hardness of silicone rubber can be tailored to the specific application, ranging from 0.1A to 100A on the Shore A hardness scale.

In one embodiment, the silicone rubber may include thermosetting silicone rubber materials and composite silicone rubber materials that include grafted polymers.

In one embodiment, the temperature-sensitive elastic polymer includes a structure represented by Formula (I):

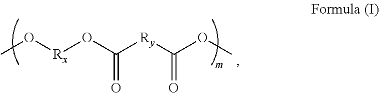

where Rₓ and R_{y} are independently represented by one or more aliphatic hydrocarbons, wherein Rₓ may represent Rₓ₁, Rₓ₂, Rₓ₃, . . . , and R_{y} may represent R_{y1}, R_{y2}, R_{y3}, . . . , etc. Rₓ and R_{y} are independently selected from the group consisting of C₁₋₁₅ straight-chain alkyl groups, C₁₋₁₅ branched alkyl groups, C₂₋₁₅ straight-chain alkenyl groups containing one or two carbon-carbon double bonds, and C₂₋₁₅ branched alkenyl groups. m is an integer greater than or equal to 1.

In one embodiment, the reaction monomer raw materials comprising Rₓ and R_{y} are derived from natural biological sources. Rₓ is preferably selected from C₃₋₆ straight-chain alkyl groups, and includes at least two alkyl components, one having an odd carbon number and the other having an even carbon number. R_{y} is preferably selected from even carbon number straight-chain alkyl groups, with a carbon number is preferably no less than 8. R_{y} is also preferably selected from unsaturated alkyl groups containing at least one carbon-carbon double bond.

In another embodiment, R_{y} is preferably selected in accordance with the regulation of Rₓ as mentioned previously, and Rₓ is preferably selected in accordance with the regulation of R_{y} as mentioned previously, with the condition that Rₓ and Ry are not selected from the same regulation.

In one embodiment, the temperature-sensitive elastic polymer include polyester. The polyester includes units of chained alkyl groups that influence the transition temperature, which can be adjusted based on the length of the alkyl chain. It also contains unsaturated alkyl units that promote crosslinking, thereby improving mechanical strength.

Polyesters belong to a polymer family characterized by ester functional groups (—O—CO—) in their backbone, typically synthesized through the polycondensation of diols and dicarboxylic acids (e.g., terephthalic acid, adipic acid, sebacic acid, isophthalic acid, itaconic acid, etc.). The diols and dicarboxylic acids used for the synthesis of polyesters or polyols may be selected from monomers derived from natural biological resources. Accordingly, the resulting manufacturing process may be considered environmentally friendly and sustainable. The transition temperature of the polyester backbone is precisely controlled by the quantity of alkyl groups and the number of carbons within those groups. Even and odd number carbon chain diacid or diol as raw materials can lead to different crystallization ability. For example, polyester synthesized from diacid and diol with even number carbon usually have high crystallization temperature and degree of crystallinity. Larger the carbon number, the higher crystallization temperature and degree of crystallinity. On the contrary, polyester synthesized from diacid and diol with odd number carbon usually is amorphous. By choosing different number and ratio between odd and even number of carbons in the Rₓ or R_{y} components, as indicated in Formula (I), polyester with controllable crystallization temperature and degree of crystallinity can be synthesized.

In one embodiment, the transition temperature and the sharpness of the mechanical phase transition are non-linearly controlled through a multivariate synergetic optimization of: (i) the precise carbon number in the straight-chain alkyl groups within the monomers; (ii) the critical molar ratio between distinct diol monomers; (iii) the stoichiometric ratio between distinct dicarboxylic acid monomers; and (iv) the controlled degree of polymerization.

It is a significant discovery of the present invention that the transition behavior within the critical temperature range cannot be achieved by merely selecting arbitrary monomers. Rather, it requires a specific odd-even carbon effect disruption where the interplay between odd-numbered and even-numbered carbon chains is strategically balanced to suppress over-crystallization while maintaining sufficient latent heat for a rapid hardness drop. Such a precise mechanical response-achieving an elastic modulus ratio (E′_{10 °C}/E′_{40 °C}) of at least 5 within a narrow 20 °C range—represents an unexpected technical result that transcends the predictable results of routine experimentation in conventional polymer blending.

In one embodiment, the temperature-sensitive elastic polymer enables the material to undergo a hardness transition within a temperature range of 10 °C to 45 °C, with a preferred range of 20 °C to 40 °C.

The hardness of the temperature sensitive silicone rubber depends on the ratio between elastic silicone and elastic polyester. The hardness can be tuned within 0.1 to 70 Shore A variation.

Materials with low melting temperature often suffer from inadequate mechanical properties, limiting their practical use. To address this challenge, the introduction of double bonds for post crosslinking, in diacids like maleic acid, teraconic acid, and itaconic acid, offers a solution. These diacids can be incorporated into the polyester backbone with their reactive C═C double bond during polymerization. During post treatment, these double bonds can be activated via radical polymerization or UV/e-beam/gamma ray curing to form a crosslinked network. This network enhances mechanical strength by restricting chain mobility, thereby improving tensile strength and modulus without significantly altering the material's low melting point. By carefully controlling the degree of crosslinking and the amount of double bond, a balance can be achieved between mechanical reinforcement and the preservation of thermal properties necessary for functions.

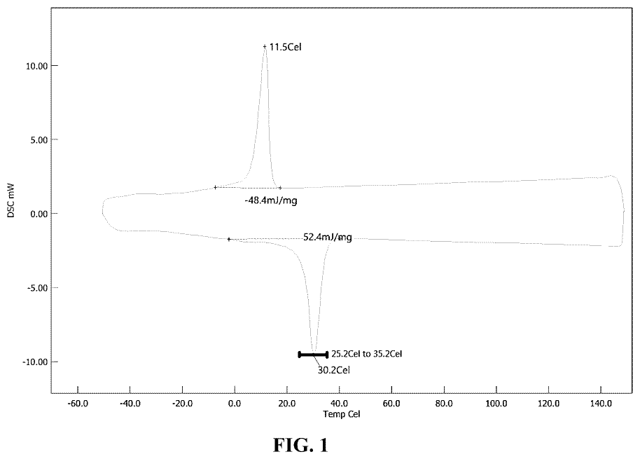

For identifying the transition temperature, the composite is tested through heating-cooling-heating scan process from −50 °C to 150 °C via DSC. Referring to FIG. 1, an endothermic peak within the second heating is determined as a sign of the transition temperature. The graph presents the second heating cycle, highlighting an endothermic peak that indicates the phase transition temperature of the material. The observed peak confirms that the composite exhibits a sharp transition temperature, which is tunable within the range of 20 °C to 40 °C by adjusting the composition of polyester. The enthalpy change (AH) associated with this transition reflects the crystallization degree of the material, ensuring its responsiveness to temperature variations. This characteristic is critical for applications requiring body-temperature adaptability, such as wearable devices.

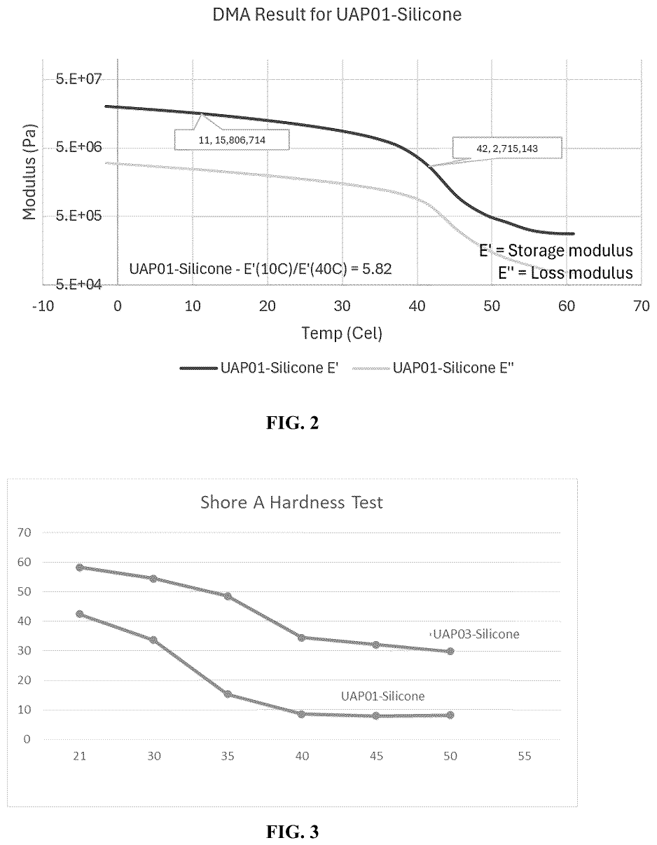

Another characterization of the composite is by dynamic mechanical analysis (DMA). It measures viscoelastic properties by applying oscillatory stress and monitoring strain response under controlled temperature or frequency. Referring to FIG. 2, the graph displays the storage modulus (elastic modulus) and loss modulus as functions of temperature. A significant drop in storage modulus is observed between 10 °C and 40 °C, indicating a substantial reduction in stiffness as temperature increases. The ratio of elastic modulus at 10 °C to that at 40 °C is no less than 5, demonstrating the material's ability to dynamically soften at body temperature. This property ensures an improved fit and comfort for skin-contact applications while maintaining structural stability at lower temperatures.

Furthermore, a Shore A hardness test (ASTM D2240) was conducted for the composite. FIG. 3 illustrates the Shore A hardness test results for the temperature-sensitive silicone rubber composite material. The data show a noticeable decrease in hardness as the temperature rises, with a difference of more than 20 Shore A units between 10 °C and 40 °C. This transition confirms the composite's temperature-dependent mechanical properties, allowing it to achieve a balance between softness and firmness. Such characteristics make the material particularly suitable for wearable devices that require both durability and adaptability to body contours.

To ensure good mechanical properties and structural integrity, the molecular weight of polyester parts is a critical factor. The polymer has a number average molecular weight in the range of 10 kDa to 100 kDa, and preferably between 20 kDa and 50 kDa.

The polyester typically exhibits a number average molecular weight greater than 10 kDa, preferred greater than 20 kDa. This specific molecular weight range ensures optimal balance between mechanical strength and elasticity. Molecular weight measurement of the polyester in this invention is conducted using gel permeation chromatography (GPC).

Additives play a critical role in the material's performance, including initiators such as peroxides (e.g., dicumyl peroxide, benzoyl peroxide, peroxyketals, and other peroxy derivatives) or platinum-based catalysts. These initiators are essential for initiating and controlling the curing or cross-linking reactions of the silicone rubber and polyester components. Depending on the desired curing mechanism and processing conditions, alternative initiators such as azo compounds, photo initiators, or thermal initiators may also be employed.

Furthermore, the additives may comprise reinforcing fillers like silica, carbon black, and calcium carbonate, which are incorporated to improve mechanical strength, durability, and thermal stability. Other silicone additives, such as plasticizers, adhesion promoters, flame retardants, UV stabilizers, and pigments, may also be included to tailor the material's properties for specific applications. These additives can influence the material's texture, elasticity, weather resistance, and overall performance, ensuring it meets the desired specifications for its intended use.

In another aspect, the present invention provides a method for fabricating the temperature-adaptive elastic silicone rubber composite. First, silicone raw materials in liquid or gel form are mixed with additives. Next, a temperature-sensitive elastic polymer is incorporated into the silicone mixture in a predetermined ratio through kneading, ensuring a homogeneous distribution of the polymer within the silicone matrix. Finally, the homogenized mixture is molded into the desired shape using either injection molding or hot press molding, with the process carried out at temperatures ranging from 50 °C to 190 °C, and preferably between 100 °C and 150 °C. Depending on the silicone rubber and polymer crosslinking agent selected, a post-curing step of 4 to 20 hours at around 100 °C to 150 °C is typically required.

The composite exhibits a crystallization-melting transition temperature that can be precisely controlled within the range from 10 °C to 45 °C, preferably 20 °C to 40 °C.

The composite material leverages the unique properties of silicone rubber and polyester to achieve an optimal balance between adaptive softness and structural integrity. When in contact with the skin or body surfaces, the polyester component softens at body temperature, allowing the material to conform precisely to the user's unique contours, reducing issues such as contact pressure, slippage, or user fatigue. Meanwhile, the composite maintains its overall firmness in areas not in direct contact with the body, providing structural stability and durability.

The composite exhibits variable hardness characteristics within a specific temperature range while retaining the skin-friendly properties of silicone rubber. This material is particularly designed to adapt its mechanical properties, such as hardness and elasticity, in response to temperature changes, making it suitable for applications where temperature sensitivity and comfort are important, such as in wearable technologies, medical devices, or consumer products.

The invention resolves the limitations of conventional silicone materials, which often exhibit static stiffness and fail to adapt to body temperature or pressure variations. By combining the adaptive softness of polyester with the structural integrity and tactile texture of silicone rubber, the composite material delivers balanced performance in terms of comfort and longevity.

Additionally, the material supports eco-friendly manufacturing practices by incorporating sustainable components, aligning with the growing demand for environmentally conscious solutions in consumer electronics, medical devices, and wearable technology. This makes the invention an ideal choice for high-performance, adaptable, and sustainable wearable applications.

### EXAMPLE

### Example 1

### Synthesis and Characterization of Temperature-Sensitive Polyester and its Integration into Silicone Composites

A temperature-sensitive polyester, UAP03, was synthesized through several steps. First, 72 g of sebacic acid (SbA), 4 g of itaconic acid (IA), 12.8 g of 1,3-propanediol (PDO), 21.6 g of 1,4-butanediol (BDO), and 0.2 g of butylated hydroxytoluene (BHT) were combined in a 250 mL three-neck round-bottom flask. Next, argon gas was purged into the flask, and the temperature was gradually increased while mixing. The flask was then heated in an oil bath at 180 °C, with continuous stirring using a magnetic stirrer, to evaporate the water produced during the condensation reaction over a period of 2.5 hours. Argon gas was continuously bubbled into the mixture through a syringe needle to maintain an inert atmosphere. After the condensation step, the temperature was increased to 220 °C, and the catalyst titanium butoxide (TBT) was added before further raising the temperature. The argon flow was stopped, and a vacuum was applied to remove the alcohol and water produced during the transesterification polymerization reaction. The flask was covered with aluminium foil for heat insulation, and the vacuum was maintained for approximately 2 hours. During this final step, the viscosity of the polyester in the flask increased significantly, indicating that the synthesis was successful and the desired molecular weight was achieved.

Once the reaction was complete, the heating and vacuum were turned off, and the flask was removed from the oil bath to cool. The polyester mixture was then poured out of the flask, allowed to cool, and weighed. It was subsequently blended with two-component silicone (hardness 20A) in a 1:1 weight ratio using a kneading machine to ensure thorough mixing. Peroxide was added to the UAP03-silicone mixture to initiate crosslinking between the polyester chains. After thorough mixing, the mixture was molded into 30×10×3 mm samples using a minijet injection molding machine, with a mold temperature of 150 °C and a cylinder temperature of 50 °C. The samples were cured in the mold for 4 hours, followed by post-curing in an oven at 100 °C for 16 hours.

The transition peak temperature of UAP03, as tested by DSC, is 40 °C. The ratio of the elastic modulus at 10 °C to the elastic modulus at 40 °C is 6.02, measured via DMA with a testing frequency of 1 Hz, indicating the mechanical modulus was temperature sensitive. The elastic modulus of UAP03-silicone is 40.1 million Pascals at 10 °C and 6.6 million Pascals at 40 °C. The Shore A hardness is 58A at 21 °C and 34A at 40 °C, indicating a hardness reduction of 24A.

### Example 2

### Synthesis and Characterization of Temperature-Sensitive Polyester and its Incorporation into Silicone Composites

A temperature-sensitive polyester, UAP01, was synthesized through several steps. First, 71.8 g of sebacic acid (SbA), 3.6 g of itaconic acid (IA), 16.7 g of 1,3-propanediol (PDO), 19.7 g of 1,4-butanediol (BDO), and 0.294 g of butylated hydroxytoluene (BHT) were combined in a 250 mL three-neck round-bottom flask. Next, argon gas was purged into the flask, and the temperature was gradually increased. The flask was then heated in an oil bath at 180 °C while being stirred with a magnetic stirrer to evaporate the water generated during the condensation reaction over a period of 2.5 hours. Argon gas was continuously bubbled into the mixture through a syringe needle to maintain an inert atmosphere. After the condensation step, the temperature was increased to 220 °C, and the catalyst titanium butoxide (TBT) was added before raising the temperature further. The argon flow was stopped, and a vacuum was applied to remove the alcohol and water produced during the transesterification polymerization reaction. The flask was then covered with aluminium foil for heat insulation, and the vacuum was maintained for approximately 2 hours. During this final step, the viscosity of the polyester in the flask increased significantly, indicating that the synthesis was successful and the desired molecular weight was achieved.

Once the reaction was complete, the heating and vacuum were turned off, and the flask was removed from the oil bath to cool. The polyester mixture was then poured out of the flask, allowed to cool, and weighed. It was subsequently mixed with a two-component silicone (hardness 20A) in a 1:1 weight ratio using a kneading machine to ensure thorough blending. Little peroxide initiator was added to induce low crosslinking. After thorough mixing, the resulting mixture was molded into 30×10×3 mm samples using a minijet injection molding machine, with a mold temperature of 150 °C and a cylinder temperature of 50 °C. The samples were then cured in the mold for 4 hours and post-cured in an oven at 100 °C for 16 hours.

The transition peak temperature of UAP01, as tested by DSC, is 30.2 °C, confirming its responsiveness within the physiological temperature range. For the composite UAP01-silicone, the ratio of the elastic modulus at 10 °C to the elastic modulus at 40 °C is 5.82, measured via DMA with a testing frequency of 1 Hz, indicating a significant temperature-triggered mechanical transition. The elastic modulus is 15.8 million Pascals at 10 °C and 2.7 million Pascals at 40 °C.

Furthermore, Shore A hardness testing showed a reduction from 42A (at 21 °C) to 8A (at 40 °C), representing a substantial hardness variation of 34 units. The larger hardness reduction was due to the low crosslink degree in polyester matrix. This lower absolute hardness value at temperatures above the transition point is a direct result of the low crosslinking degree within the UAP01 polyester matrix when compared to more highly crosslinked variants. While the material achieves excellent anatomical conformability, the low crosslink density allows for greater chain mobility in the softened state. This demonstrates that the hardness gradient and the resulting mechanical response can be precisely tuned by controlling the extent of the crosslinked network within the composite.

### Example 3

### Synthesis and Characterization of Temperature-Sensitive Polyester and its Incorporation into Silicone Composites

A temperature-sensitive polyester, UAP06, was synthesized through several steps. First, 72 g of sebacic acid (SbA), 1.92 g of itaconic acid (IA), 18.1 g of 1,3-propanediol (PDO), 13.8 g of 1,4-butanediol (BDO), and 0.2 g of butylated hydroxytoluene (BHT) were combined in a 250 mL three-neck round-bottom flask. Next, argon gas was purged into the flask, and the temperature was gradually increased. The flask was then heated in an oil bath at 180 °C while being stirred with a magnetic stirrer to evaporate the water generated during the condensation reaction over a period of 2.5 hours. Argon gas was continuously bubbled into the mixture through a syringe needle to maintain an inert atmosphere. After the condensation step, the temperature was increased to 220 °C, and the catalyst titanium butoxide (TBT) was added before raising the temperature further. The argon flow was stopped, and a vacuum was applied to remove the alcohol and water produced during the transesterification polymerization reaction. The flask was then covered with aluminium foil for heat insulation, and the vacuum was maintained for approximately 2 hours. During this final step, the viscosity of the polyester in the flask increased significantly, indicating that the synthesis was successful and the desired molecular weight was achieved.

Once the reaction was complete, the heating and vacuum were turned off, and the flask was removed from the oil bath to cool. The polyester mixture was then poured out of the flask, allowed to cool, and weighed. It was subsequently mixed with a two-component silicone (hardness 20A) in a 1:1 weight ratio using a kneading machine to ensure thorough blending. No peroxide initiator was added. After thorough mixing, the resulting mixture was molded into 30×10×3 mm samples using a minijet injection molding machine, with a mold temperature of 150 °C and a cylinder temperature of 50 °C. The samples were then cured in the mold for 4 hours and post-cured in an oven at 100 °C for 16 hours.

The transition peak temperature of UAP06-silicone, as tested by DSC, is 30.4 °C. For the composite UAP06-silicone, the ratio of the elastic modulus at 20 °C to the elastic modulus at 50 °C is 64, measured via DMA with a testing frequency of 1 Hz. The elastic modulus is 37.4 million Pascals at 20 °C and 0.6 million Pascals at 50 °C, which confirms the extreme temperature sensitivity of the mechanical modulus. The Shore A hardness testing further showed a reduction from 65A (at 21 °C) to 7A (at 45 °C), representing a dramatic hardness drop of 58 units. This exceptionally large decrease in both elastic modulus and hardness is attributed to the absence of a crosslinked network within the UAP06 polyester matrix, allowing for maximum chain mobility upon reaching the transition temperature.

Collectively, Examples 1, 2, and 3 demonstrate that a wide range of hardness gradients and mechanical transition profiles can be engineered by precisely controlling the molecular structure of the polyester and the extent of crosslinking within the composite matrix.

### Example 4

### Evaluation of Mechanical Integrity and Durability Under Cyclic Temperature Variations

To substantiate the durability and long-term performance of the temperature-sensitive composite, particularly regarding its ability to maintain mechanical integrity under repeated thermal stress, a cyclic heating-cooling study was conducted. The test specimen utilized was a silicone composite comprising crosslinked polyester (UAP03) and ShinEtsu KEG2000-20A/B silicone in a 50 wt % ratio.

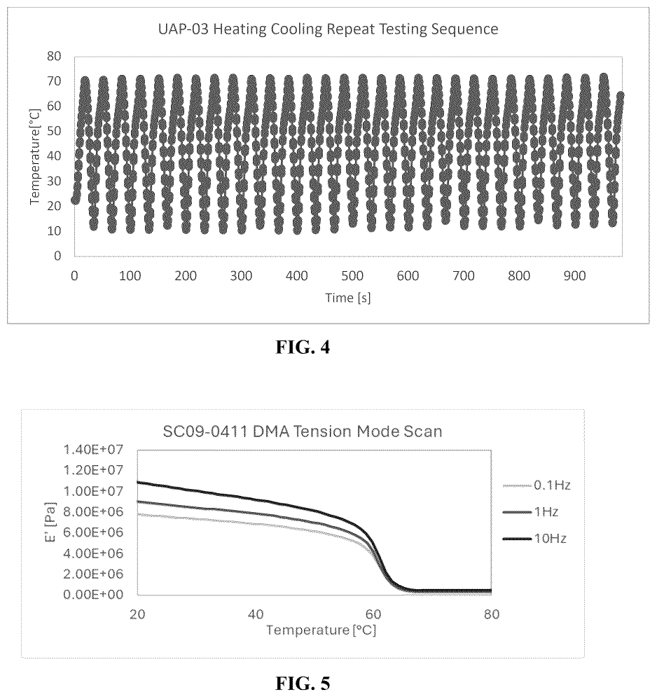

Referring to FIG. 4, the specimen was subjected to 30 repeated heating and cooling cycles within an 18-hour period. The temperature was precisely cycled between approximately 10 °C and 70 °C, as shown in the UAP-03 Heating Cooling Repeat Testing Sequence. This rigorous thermal oscillation represents a demanding environment intended to simulate long-term wearable use, where the material must repeatedly soften upon skin contact and recover its initial state upon removal.

The E′ was monitored during the 1st cycle and after the 30th cycle at various frequencies. As summarized in Table 1 and Table 2, the elastic modulus values at both 25 °C and 45 °C remained remarkably stable. For instance, at a frequency of 1 Hz, the $E′(25 °C)/E′(45 °C) ratio was 2.55 in the first cycle and 2.66 after 30 cycles. This data demonstrates that the thermo-responsive phase transition remains reversible and consistent, without degradation of the crosslinked polymer network or loss of temperature sensitivity.

TABLE 1
DMA of UAP03 First Cycle

| | 0.1 Hz | 1 Hz | 10 Hz |
|---|---|---|---|
| E′(25 °C) | 22.8 | 25.8 | 29.0 |
| E′(45 °C) | 9.51 | 10.1 | 14.1 |
| E′(25 °C)/E′(45 °C) | 2.40 | 2.55 | 2.54 |

TABLE 2
DMA of UAP03 After 30 Cycles

| | 0.1 Hz | 1 Hz | 10 Hz |
|---|---|---|---|
| E′(25 °C) | 21.1 | 25.0 | 27.1 |
| E′(45 °C) | 9.07 | 9.39 | 10.6 |
| E′(25 °C)/E′(45 °C) | 2.33 | 2.66 | 2.54 |

Further verification was performed through Shore A hardness testing before and after the 30 thermal cycles. As shown in Table 3, the composite maintained a consistent hardness of 58A at 25 °C and 32A at 45 °C across the entire duration of the test.

TABLE 3

| | Before Repeat | After 30 Repeat |
|---|---|---|
| Shore A Hardness | Heating-Cooling | Heating-Cooling |
| of UAP03 | Cycles | Cycles |
| 25 °C | 58 | 58 |
| 45 °C | 32 | 32 |

The stable results from FIG. 4 and Tables 1-3 confirm that the dual-phase synergistic structure prevents irreversible deformation or mechanical fatigue. Unlike conventional linear elastomers that may suffer from permanent softening, the composite of the present invention maintains its “soft-yet-firm” characteristic and structural integrity under cyclic temperature variations.

### Example 5

### Thermal Characterization of Synthesized Polyesters

To further evaluate the thermodynamic properties of the temperature-sensitive components, the polyesters synthesized in Examples 1, 2, and 3 (UAP03, UAP01, and UAP06, respectively) were analyzed using Differential Scanning calorimetry (DSC). This analysis identifies the phase transition behavior critical for ensuring anatomical adaptability at human body temperatures. The thermal parameters, including melting temperature (Tₘ), crystallization temperature (Tc), and their corresponding enthalpy changes (AH), were measured during a controlled heating-cooling cycle. The results are summarized in Table 4 below.

TABLE 4
DSC test results of UAP polyesters

| Sample | Tm (°C) | H_{Tm} (J/g) | Tc (°C) | H_{Tc} (J/g) |
|---|---|---|---|---|
| UAP-1 | 30 | 52 | 12 | −48 |
| UAP-3 | 40 | 60 | 21 | −50 |
| UAP-6 | 30 | 52 | 10.5 | −54 |

*Tm = melting temperature (transition temperature)
*Tc = crystallization temperature
*H = heat capacity

The DSC data presented in Table 8 provide a quantitative foundation for the superior thermo-responsive performance of the synthesized polyesters. The melting temperatures (Tₘ) for UAP01, UAP03, and UAP06 are observed at 30 °C, 40 °C, and 30 °C, respectively. These values fall precisely within the critical physiological window of 20 °C to 40 °C, which is essential for wearable applications that must respond to human body temperature. This stands in sharp contrast to conventional materials such as polycaprolactone (PCL), which exhibits a melting point far exceeding skin tolerance, typically above 55 °C.

The substantial enthalpy of melting (ΔHTₘ) values, ranging from 52 J/g to 60 J/g, indicate a high degree of crystalline regularity that is strategically disrupted only upon reaching the transition temperature. The significant latent heat associated with these transitions ensures a sharp phase change. As the material absorbs body heat, this high energy density facilitates a non-linear, rapid reduction in hardness and modulus—rather than a gradual, sluggish softening-thereby enabling immediate anatomical conformability.

Comparing UAP01 and UAP03 further demonstrates the effectiveness of the molecular engineering described in the present invention. By strategically regulating the alkyl chain lengths and odd-even carbon ratios within the polymer backbone, the Tₘ can be precisely shifted (e.g., from 30 °C to 40 °C) while maintaining high crystallinity. This level of tunability allows the material to be customized for specific device requirements, such as earbud tips needing rapid softening versus watchbands requiring a higher stability threshold.

The crystallization temperatures (T_{c}) recorded, ranging from 10.5 °C to 21 °C, ensure that the material remains in a softened, comfortable state while in contact with the skin, but can recover its structural stiffness when removed from the body and cooled. The consistent enthalpy of crystallization (ΔH_{Tc}) values confirm the reversibility and durability of the thermo-responsive phase transition. This prevents permanent deformation even after repeated use, validating the synergistic dual-phase structure that maintains mechanical integrity under cyclic temperature variations.

### Comparative Example 1

### Silicone Composite Based on Polycaprolactone (PCL)

A commercially available PCL, CAPA®6250, which lacks unsaturated double bonds for post-crosslinking, was mixed with a two-component silicone (hardness 20A) in a 1:1 weight ratio using a kneading machine. After thorough mixing, the resulting mixture was molded into 30×10×3 mm samples using a minijet injection molding machine, with a mold temperature of 150 °C and a cylinder temperature of 50 °C. The samples were then cured in the mold for 4 hours and post-cured in an oven at 100 °C for 16 hours.

The mechanical modulus of the mixed sample, PCL-silicone, was tested by DMA with a testing frequency of 0.1 Hz, 1 Hz, and 10 Hz, which showed the transition temperature is at 60-65 °C. The transition temperature was not in the range of body temperature. The Shore A hardness was measured: 48A at 25 °C, 34A at 45 °C, and 8A at 60 °C. The PCL-silicone composite did not exhibit hardness transition at body temperature. Moreover, at 60 °C, the hardness dramatically dropped to 8A, indicating the lack of crosslinking and structural strength.

This precipitous decline, without reaching a stable plateau, directly indicates a lack of crosslinking and insufficient structural strength, leading to structural collapse once the melting point of the linear PCL is reached. Consequently, such conventional PCL-based composites fail to achieve the synergistic balance of sharp body-temperature softening and high-temperature structural retention provided by the present invention.

### Comparative Example 2

In this example, a commercially available polycaprolactone (PCL), Ingevity CAPA®5980, was utilized to prepare a comparative silicone composite, designated as SC09, to evaluate its thermal and mechanical performance against the synthesized polyesters of the present invention.

Specifically, the CAPAR5980 was mixed with a two-component silicone rubber (ShinEtsu KEG2000-20A/B, hardness 20A) in a 1:1 weight ratio using a kneading machine. The resulting mixture was molded into test samples and cured under conditions consistent with the methods described in the previous examples.

The Shore A hardness of the SC09 sample was measured at 25 °C, 40 °C, and 65 °C. As shown in Table 5, the hardness of SC09 was 48 at 25 °C and only slightly decreased to 47 at 40 °C. This demonstrates that the silicone composite with commercial PCL fails to exhibit significant softening within the critical physiological window of 20 °C to 40 °C. Furthermore, when the temperature was increased to 65 °C, the hardness of SC09 dramatically dropped to 8, indicating that the material becomes excessively fragile and lacks the structural integrity required for wearable applications after reaching its softening point. In contrast, the sample comprising the synthesized crosslinked polyester of the present invention (UAP03) showed a controlled transition from 58 (at 25 °C) to 34 (at 40 °C), while maintaining a stable hardness of 32 even at 65 °C due to its crosslinked network.

TABLE 5

| Temperature | 25 °C | 40 °C | 65 °C |
|---|---|---|---|
| Shore A Hardness for SC09 | 48 | 47 | 8 |
| (Silicone with CAPA5980 polyester) | | | |
| Shore A Hardness for UAP03 | 58 | 34 | 32 |
| (Silicone with crosslinked polyester) | | | |

DMA testing further confirmed the insufficient thermal responsiveness of the commercial polyester blend. As summarized in Table 6, the elastic modulus (E′) for SC09 at 25 °C was 87.0 MPa and only decreased to 74.4 MPa at 45 °C, resulting in a low E′ (25)/E′ (45 °C) ratio of 1.16. This ratio is significantly lower than the values achieved by the present invention (e.g., UAP03), highlighting that SC09 lacks the necessary temperature-triggered adaptability.

Referring to FIG. 5, the DMA tension mode scan of SC09 under multiple frequencies (0.1 Hz, 1 Hz, and 10 Hz) illustrates that the E′ remains relatively high and static from 20 °C to 50 °C. The characteristic sharp drop in modulus, indicating the phase transition, only occurs between 58 °C and 65 °C. This transition temperature is well above the human skin tolerance and typical body temperature range, rendering it ineffective for adaptive wearable applications.

TABLE 6

| | | | E′(25)/ | |
|---|---|---|---|---|
| | 25 °C | 45 °C | E′(45 °C) | 65 °C |
| E′(1 Hz) for SC09 | 87.0 MPa | 74.4 MPa | 1.16 | 0.46 MPa |
| (Silicone with | | | | |
| CAPA5980 Polyester) | | | | |
| E′(1 Hz) for UAP03 | 25.8 MPa | 10.9 MPa | 2.37 | 0.89 MPa |
| (Silicone with | | | | |
| Crosslinked Polyester) | | | | |

### Comparative Example 3

### Comparative Evaluation of Structural Integrity Between Crosslinked and Non-Crosslinked Polyester-Silicone Composites

To further substantiate the technical effect of the post-crosslinked network in maintaining structural integrity, a comparative study was conducted between silicone composites featuring crosslinked polyester (UAP03) and non-crosslinked polyester (UAP06). Both samples were prepared using ShinEtsu KEG2000-20A/B silicone and the respective polyester at a 50 wt % loading ratio, keeping all other processing conditions identical.

The Shore A hardness was measured at 25 °C (room temperature) and 45 °C (above the transition point). As summarized in Table 7, while both materials exhibit significant softening, the non-crosslinked composite (UAP06-silicone) shows a dramatic drop in hardness to a value of only 7 at 45 °C. In contrast, the crosslinked composite (UAP03-silicone) retains a stable hardness of 32 at the same temperature.

This result indicates that without the crosslinked network, the temperature-sensitive phase becomes excessively soft, failing to provide the necessary mechanical support. The presence of crosslinking in UAP03 ensures that the composite remains “soft-yet-firm,” providing anatomical comfort without losing its functional shape

TABLE 7

| Temperature | 25 °C | 45 °C |
|---|---|---|
| Shore A Hardness for UAP06 | 65 | 7 |
| (Silicone with Non-Crosslinked Polyester) | | |
| Shore A Hardness for UAP03 | 58 | 32 |
| (Silicone with Crosslinked Polyester) | | |

The E′ results from DMA testing at 1 Hz further confirm this technical distinction. As shown in Table 8, the elastic modulus of the non-crosslinked UAP06-silicone drops precipitously from 36 MPa at 25 °C to 0.58 MPa at 45 °C, resulting in an extremely high E′ (25)/E′ (45 °C) ratio of 61.5.

While such a high ratio indicates extreme sensitivity, the absolute modulus value of 0.58 MPa is insufficient for practical wearable applications. Such low stiffness leads to excessive structural deflections and a failure to maintain the device's tactile texture or secure fit under pressure. Conversely, the crosslinked UAP03-silicone maintains a modulus of 10.9 MPa at 45 °C, which represents a balanced mechanical state that preserves elasticity and load-bearing capacity even while in a softened state.

TABLE 8

| Temperature | 25 °C | | 45 °C | E′(25)/E′(45 °C) |
|---|---|---|---|---|
| E′(1 Hz) for UAP06 | 36 | MPa | 0.58 MPa | 61.5 |
| (Silicone with Non- | | | | |
| Crosslinked Polyester) | | | | |
| E′(1 Hz) for UAP03 | 25.8 | MPa | 10.9 MPa | 2.37 |
| (Silicone with | | | | |
| Crosslinked Polyester) | | | | |

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

What is claimed is:

1. A temperature-sensitive silicone-rubber-based composite, comprising:
20 to 90 parts by weight of a silicone rubber matrix;
10 to 80 parts by weight of a temperature-sensitive elastic polymer dispersed within the silicone rubber matrix; and
0.1 to 30 parts by weight of additives including a crosslinking initiator;
wherein the temperature-sensitive elastic polymer comprises an aliphatic unsaturated polyester having a back-bone structured to undergo a crystalline-to-amorphous phase transition within a physiological temperature window of 20 °C to 40 °C; and
wherein the silicone rubber matrix and a post-crosslinked network of the aliphatic unsaturated polyester form a dual-phase synergistic structure, such that the temperature-sensitive silicone-rubber-based composite exhibits a reduction in Shore A hardness of at least 20 units upon reaching the phase transition while maintaining structural elasticity.

2. The temperature-sensitive silicone-rubber-based composite of claim 1,
wherein the aliphatic unsaturated polyester comprises a polyester structure represented by Formula (I): 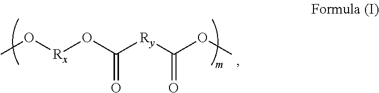
wherein Rₓ and R_{y} are independently selected from the group consisting of C₁-15 straight-chain alkyl groups, C₁₋₁₅ branched alkyl groups, and C₂₋₁₅ alkenyl groups containing at least one carbon-carbon double bond, and m is an integer greater than or equal to 1.

3. The temperature-sensitive silicone-rubber-based composite of claim 2, wherein Rₓ comprises at least two alkyl components, one having an odd carbon number and the other having an even carbon number, configured to regulate the crystalline packing of the polyester.

4. The temperature-sensitive silicone-rubber-based composite of claim 2, wherein R_{y} comprises an unsaturated aliphatic group configured to form the post-crosslinked network with the silicone rubber matrix.

5. The temperature-sensitive silicone-rubber-based composite of claim 1, wherein the temperature-sensitive elastic polymer exhibits a melting enthalpy of at least 50 J/g.

6. The temperature-sensitive silicone-rubber-based composite of claim 1, wherein the temperature-sensitive elastic polymer has a melting temperature between 30 °C and 40 °C.

7. The temperature-sensitive silicone-rubber-based composite of claim 1, wherein the temperature-sensitive elastic polymer has a crystallization temperature between 10 °C and 21 °C.

8. The temperature-sensitive silicone-rubber-based composite of claim 1, wherein the ratio of an elastic modulus at 10 °C to an elastic modulus at 40 °C of the temperature-sensitive silicone-rubber-based composite is at least 5.8.

9. The temperature-sensitive silicone-rubber-based composite of claim 1, wherein the temperature-sensitive silicone-rubber-based composite exhibits a Shore A hardness variation of 0.1 to 70 units within a temperature range from 10 °C to 45 °C.

10. The temperature-sensitive silicone-rubber-based composite of claim 1, wherein the temperature-sensitive elastic polymer has a weight average molecular weight in the range of 10 kDa to 100 kDa.

11. The temperature-sensitive silicone-rubber-based composite of claim 1, wherein the silicone rubber matrix comprises a thermosetting silicone selected from the group consisting of polydimethylsiloxane (PDMS) and vinyl-functionalized silicone elastomers.

12. The temperature-sensitive silicone-rubber-based composite of claim 1, wherein the additives comprise peroxides, platinum-based catalysts, azo compounds, photo initiators or thermal initiators, reinforcing fillers, or other silicone additives.

13. The temperature-sensitive silicone-rubber-based composite of claim 1, wherein the post-crosslinked network is formed by radical polymerization of unsaturated units within the polyester triggered by the crosslinking initiator during a molding process.

14. The temperature-sensitive silicone-rubber-based composite of claim 1, wherein the temperature-sensitive silicone-rubber-based composite maintains a Shore A hardness at 45 °C after at least 30 repeat heating-cooling cycles between 10 °C and 70 °C.

15. The temperature-sensitive silicone-rubber-based composite of claim 1, wherein the temperature-sensitive silicone-rubber-based composite maintains an elastic modulus of no less than 2.7 MPa at 40 °C.

16. The temperature-sensitive silicone-rubber-based composite of claim 1, wherein the temperature-sensitive silicone-rubber-based composite is an injection-molded component for a wearable device, configured to anatomically conform to a user's skin surface upon contact.

17. A method for fabricating a temperature-sensitive silicone-rubber-based composite, comprising:
mixing a silicone rubber with additives to form a base mixture;
incorporating a temperature-sensitive elastic polymer into the base mixture;
homogenizing the mixture via a kneading process conducted under an inert gas atmosphere; and
molding the homogenized mixture into a predetermined shape at a temperature between 100 °C and 190 °C to simultaneously trigger shaping and crosslinking of the temperature-sensitive elastic polymer.

18. The method of claim 17, further comprising a post-curing step at a temperature between 100 °C and 150 °C for a duration of 4 to 20 hours.

19. The method of claim 17, wherein the molding process is performed under vacuum conditions to minimize air entrapment and defects within the dual-phase synergistic structure.

20. The method of claim 17, wherein the temperature-sensitive elastic polymer is pre-synthesized from bio-based diols and dicarboxylic acids to have a melting temperature tailored to 20 °C to 40 °C via regulation of odd-even carbon ratios in its molecular backbone.
